(19) United States
(12) Patent Application Publication
(10) Pub. No.: US 2009/0012834 A1
(43) Pub. Date: Jan. 8, 2009

(54) Compliance Management System

(76) Inventor: Brian Fahey, Blackrock (IE)

Correspondence Address: PROSKAUER ROSE LLP, ONE INTERNATIONAL PLACE, BOSTON, MA, 02110, US

(21) Appl. No.: 11/773,259

(22) Filed: Jul. 3, 2007

(51) Int. Cl. G06F 9/46

(52) U.S. Cl. 705/9

(57) ABSTRACT

A compliance management system that includes a task module configured to process a task comprising task attributes, to associate the tasks with a workflow, and to assign the task to one or more individuals based on a task assignment attribute, the task assignment attribute representing one or more individuals responsible for the task. The system also includes a case module configured to process a case comprising case attributes and to track the resolution and method of resolution of the case and a document module configured to store or retrieve documents, and to associate the documents with one or more tasks or cases.

### FIELD OF THE INVENTION

The present invention related generally to the use of a computerized system to manage and monitor compliance activities.

### BACKGROUND

Recent legislative and judicial decisions have increased the pressure on large companies, and particularly corporate officers, to demonstrate a culture of compliance with both external and internal compliance laws and regulations. Compliance management usually create policies that are appropriate for their firm to meet the regulations and define procedures that meet and ensure the policies are completed. The procedures are planned activities that must be monitored by the compliance management. In addition, unplanned compliance issues occur and they must be resolved as part of compliance management.

Compliance management systems are narrowly-tailored, point-solution based tools designed to perform a functions for a specific regulation e.g. a SOX solution, and anti-money laundering solution, etc. The tools are not designed to allow for an integrated compliance overview that would allow for cross-functional compliance management. Finally, it is neither simple, straightforward, nor easy to compile information retrieved from multiple compliance management systems because the differences and the irregularities between the functionally-specific systems make attempts at compilation are expensive and time-consuming. As a result, most organizations are forced to manage different compliance functional areas independently, and any integrated reporting must be compiled manually.

### SUMMARY

In one approach, a computer system may be used to manage compliance. In one aspect, this includes a system that includes a task module configured to process a task, to associate the task with a workflow, and to assign the task to one or more individuals based on an assignment attribute; a case module configured to process a case comprising case attributes and track the resolution and method of resolution of the case; and a document module configured to store or retrieve documents, and to associate the documents with one or more tasks or cases.

In another approach, a computerized method may be used to manage compliance. In one aspect, the method includes defining a plurality of task attributes associated with a task, associating the task with a workflow, assigning the task to one or more individuals based on the assignment attribute, notifying the one or more individuals identified by the assignment attribute, recording a case by defining at least one case attributes, notifying the one or more individuals identified by the assignment or owner attributes of the case, and storing documents in a central document database.

The above mentioned aspects can include one or more of the following feature. An assignment attribute represent one or more individuals responsible for the task or case. A task attribute includes an assignment attribute that identifies one or more individuals who are responsible for the task, a compliance category attribute, a recurrence pattern attribute, an email notification attribute, one or more escalation attributes, and at an optional associated document attribute. A case attribute comprises a compliance category attribute, an owner attribute representing one or more individuals responsible for monitoring the case, and an assignment attribute representing one or more individuals responsible for resolving the case.

The above mentioned aspects can include one or more of the following features. An application server can be configured to generate a report based on a filter that includes task attributes, case attributes, or any combination thereof. A storage module wherein the storage module maintains data about the documents, task and case data, workflow data, user and customer data, and data for specific industry needs. The storage module can be configured to maintain data related to emails, instant message, and voicemail. A notification module configured to send emails or updates to the one or more individuals identified by the task assignment attribute, the case assignment attribute, the owner attribute associated with the case, or any combination thereof. An application specific module, configured to maintain data specialized to an industry or user group. And a plurality of one or more servers wherein the task module, the case module, the document module, the storage module, the application specific module, or any combination thereof preside on the plurality of one or more servers.

Any of the above aspects can include one or more of the following features. One or more of the documents can be associated with the task or case. A report page can be generated based on a filter that includes at least the task or case attributes and an overview page can be generated wherein the overview page reflects a status of the tasks and cases. In another aspect a reminder or notification process can be executed before an assignment is due and an escalation process can be executed if a task is not completed before a due date. The method can also include defining a plurality of task attributes and associating the plurality of task attributes with a functional area. The functional area can be compliance management, policies and procedures, firm documents, trading oversight, investor management, client management, licensing and registration, email, tools and learning, administrative, or any combination thereof. In one aspect a single plurality of task attributes can be associated with multiple functional areas. The method can also include defining a plurality of case attributes associated with the functional areas. In one aspect the functional areas can be compliance management, policies and procedures, firm documents, trading oversight, investor management, client management, licensing and registration, email, tools and learning, administrative, or any combination thereof. In one aspect a single plurality of case attributes can be associated with multiple functional areas.

Any of the above aspects can include one or more of the following features. A set of core attributes can be associated with a task type. A different set of core attributes can be associated with every case type. A set of custom attributes can be associated with a task type or case type. Compliance activities can be mapped to a plurality of task types and/or case types. A plurality of compliance activities are all of the compliance activities of an industry or organization. A plurality of predefined task types and/or case types can be defined as associated with an industry. One or more custom attributes of a task type and/or case type can be associated with an industry. A plurality of predefined task/case types can be associated with a functional area, and one or more of a plurality of functional areas can be associated with an organization, group, or industry.

Any of the above described methods and/or apparatuses can include one or more of the following advantages. An advantage of the disclosed technique is that it provides a generalized methodology for the monitoring of many different kinds of compliance activities and it decreases compliance related costs through the automation of manual activities. Another advantage if that it provides peace of mind to management or compliance officers that compliance processes are being followed, and proves compliance by memorializing compliance activities. A third advantage is that organizations can easily compile an overview report of all compliance activities via the core attributes common to a task type or the core attributes common to a case type.

Other aspects and advantages of the present invention will become apparent from the following detailed description, taken in conjunction with the accompanying drawings, illustrating the principles of the invention by way of example only.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 shows an overview of how the tasks, assignment, events and documents perform the core components for delivering compliance monitoring activities of the sample business uses.

FIG. 2 shows an exemplary elements of a compliance management system.

FIG. 3 shows exemplary function and capabilities of the compliance system.

FIG. 4 shows a screen shot associated with creating a generic task, including the task attributes that may be defined.

FIG. 5 shows an illustrative list of task types that may be utilized by a user in compliance management.

FIGS. 6A-6B shows an illustrative task type that has additional attributes other than the core attributes

FIG. 7 shows a screen shot used to generate a report including the filter criteria.

FIG. 8 shows a list of tasks and some of the core task attributes associated with every task type.

FIG. 9 shows a user's list of assignments and some of the core assignment attributes associated with the assignments.

FIG. 10 shows a screen shot associated with creating a new case, including the case attributes that may be defined.

FIG. 11 shows an illustrative list of case types that may be utilized by a user while managing compliance cases.

FIG. 12 shows a list of cases including the core case attributes.

FIG. 13 shows a list of cases owned by at least one individual.

FIG. 14 shows a list of cases created by an individual.

FIG. 15 shows a screen shot associated with a document library database.

FIG. 16 shows an illustrative list of documents that are associated with the policy and procedures functional area.

FIG. 17 shows a screen shot associated with adding a policy or procedure document and some core.

FIGS. 18A-18D show lists associated with additional information categories.

FIGS. 19A-19D show illustrative examples of overview displays.

Variations, modifications, and other implementations of what is described herein will occur to those of ordinary skill in the art without departing from the spirit and the scope of the invention. Accordingly, the invention is to be not limited by the following illustrative descriptions.

### DETAILED DESCRIPTION

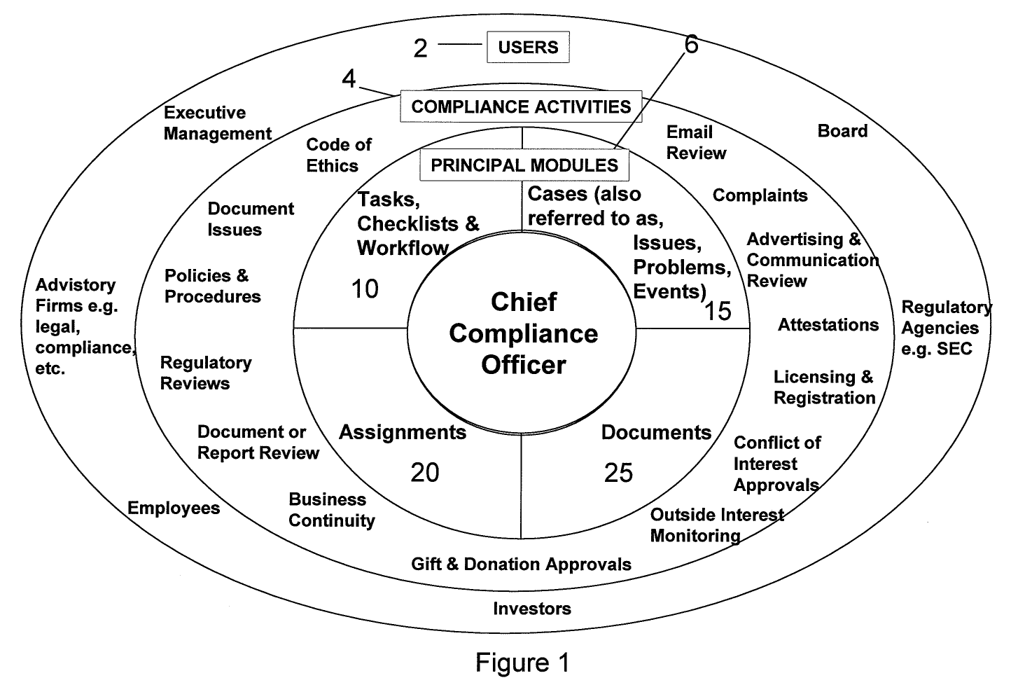

Compliance monitoring and reporting is used to satisfy corporate boards, investors, and state and federal regulators and agencies. Compliance monitoring requires users 2, including corporate officers and regulators to monitor and review a wide variety of compliance issues and activities 4 (e.g., ethics, advertising, attestations, email review, licensing and registration) in addition to consistent documentation of unplanned occurrences and their resolution (e.g., customer complaints and conflicts of interest). FIG. 1 illustrates the relationship between examples of these requirements and the principal modules 6 of a compliance management system, including tasks 10, cases 15, assignments 20, and documents 25, that embodies the principles of the invention.

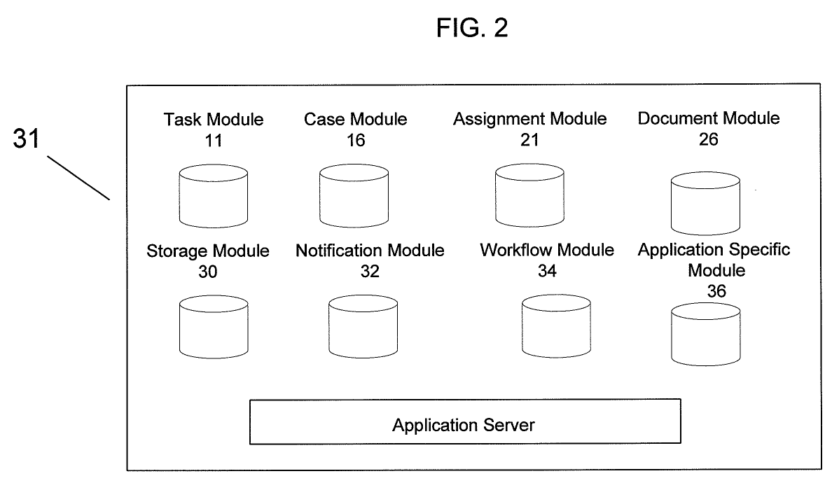

FIG. 2 shows the elements included in one implementation of a compliance management system. The system can include a task module 11 configured to process a task 10, a case module 16 configured to process a case 15, an assignment module 21 configured to process an assignment 20, a workflow module 34 configured to process a workflow, a document module 26 configured to retrieve or store one or more documents 25, and an application specific module 36 configured to store and process information specific to an organization or industry. The task module 11, the case module 16, the assignment module 21, the document module 26, the storage module 30, the notification module 32, the workflow module 34 and the application specific module 36, or any combination of these, can reside on one or more servers 31. A user can initiate the monitoring of a compliance activity by entering or defining the attributes associated with a case 15 or a task 10. In another implementation, the attributes associated with a task or case can be defined automatically by the system. A user can manually add a document to the document library (i.e., a database). And in some implementations, one or more documents are automatically associated with a task and/or case.

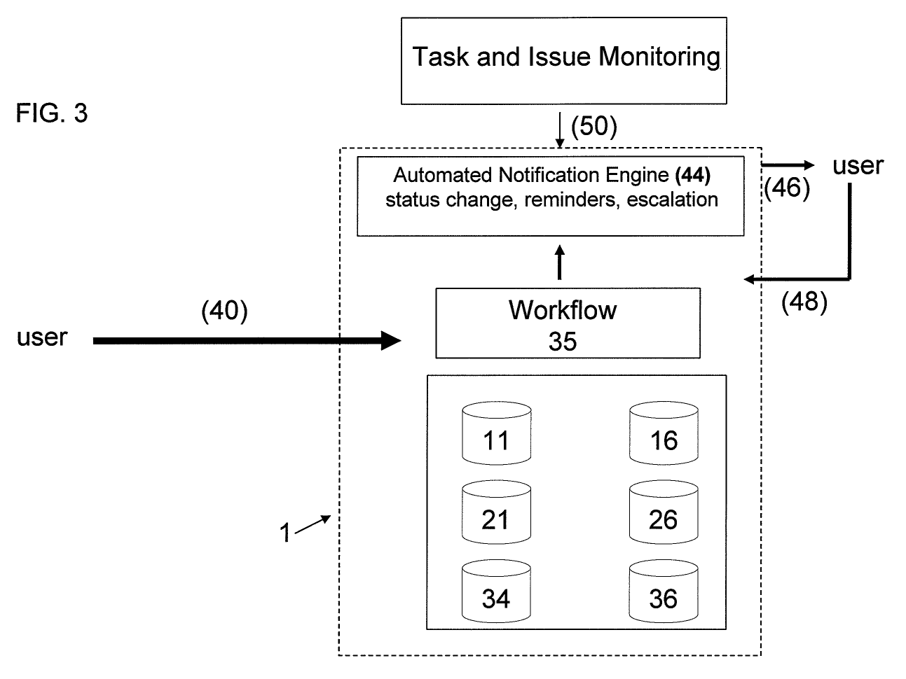

FIG. 3 shows one implementation of a compliance management system (1) that utilizes the elements of FIG. 2. in one implementation. In FIG. 3, a user defines (40) the attributes associated with a new case 15 or a new task 10. For every new task 15, a new workflow 35 is associated with the task. The workflow 35 can define the assignment attributes in some implementations. In some implementations, the user defines the attributes of the new assignment that are associated with the new task.

All new tasks or cases are associated with a workflow 35. The workflow determines the steps of the case or task and who each step is assigned to, based on the assignment attribute. For a case, the workflow 35 can also determine the owner of the case based on the owner attribute. When the workflow processes the assignee attribute, the workflow creates an assignment. An assignment is a single instance of a task that is assigned to an individual. Once a new task or case is processed through the workflow, status changes, reminders, notification, and/or escalation statements can be generated (44) by an automated notification engine.

A user who owns a task or case, or a user who is assigned a task or case, receives (46) notification of the task, case, or assignment. In some embodiments, the notification is provided over email or other electronic delivery system to one or more individuals. Once the user receives the notification, he/she can log-in (48) to the compliance system to complete or monitor the task, case or assignment. In some implementations, the user may log-in to the compliance system to review (50) the status of a case or task. In some implementations, when the user logs in into the compliance system, he/she can also retrieve or review one or more documents associated with the task, case, or assignment.

In some implementations of the compliance management system, an existing task or case may be monitored or reviewed by a user. A user may be any individual who is associated with an organization or group. Examples of users include corporate officers, compliance officers, board members, or any other level of employee. A user's access to the compliance management system can depend upon the authorization level of the user within the group or organization.

A user may only be able to review and monitor the tasks and cases that he/she is assigned, owns, or creates. A user can use a report page to generate a task, case or assignment list. The report page includes filters associated with the tasks, cases and/or assignments attributes. In some implementations, a user has read only access to the tasks, cases, or assignments lists. In some implementations, a user can have access to the compliance lists and records of all other employees that the user supervises. However, in some implementations, the user can associate or disassociate one or more documents with his/her list of task, cases, or assignments to assist him/her in complying with his/her responsibilities. In addition, a user may be allowed to add or remove copies of documents to and from a central document database. A user can also compile and generate an overview that reflects the status of the tasks, cases, or assignments associated with the user. A user may also be able to alter or change the attributes associated with the tasks and cases assigned, owned, or created by the other employees that the user supervises. However, a user may not have access to the records and lists associated with the tasks, cases, and assignments of employees who supervise the user.

All compliance activities can be managed with a combination of tasks 10, cases and/or documents. Tasks are planned activities that can occur once or recur at periodic intervals (e.g., daily, weekly, monthly, quarterly, or annually). After a task 11 is processed through a workflow 23, it becomes an assignment 15 for an individual or group of individuals. However, before a task 11 can be processed by a workflow 23, the attributes 13 must be defined.

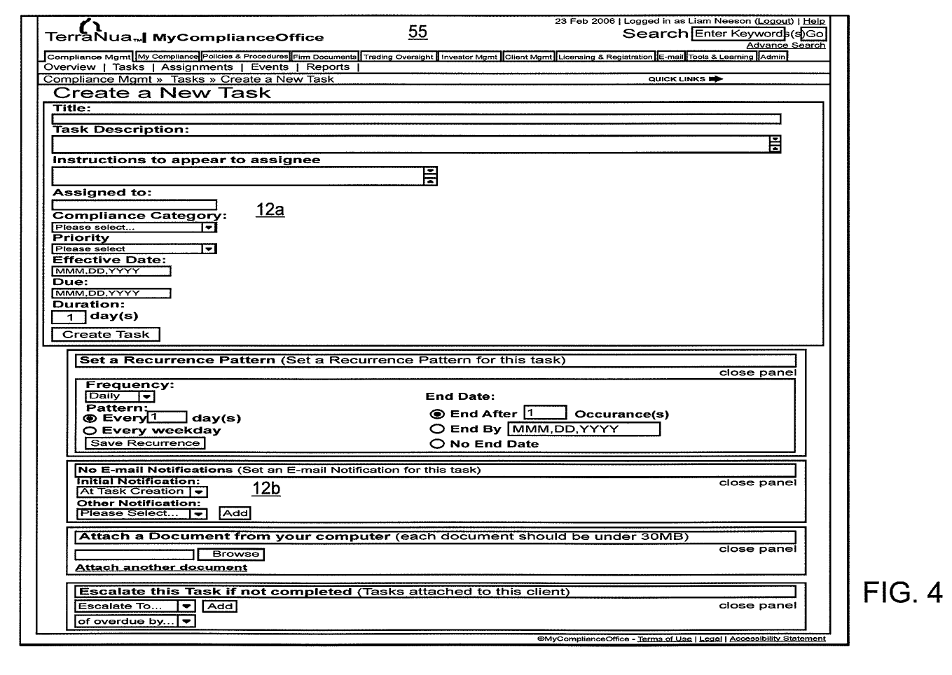

FIG. 4 shows an illustrative screen shot used to create a new task in the Compliance Management functional area. Other functional areas 55 include My Compliance, Policies and Procedure, Firm Documents, Trading Oversight, Investor Management, Client Management, Licensing and Registration, Email, Tools and Learning, and Administrative. Functional areas are based on the needs of the organization and/or industry and the title of a functional area depends on the function of the type of tasks and cases that are organized under the functional area category. Since not all functional areas are necessary for the compliance management of all organizations, the inclusion of functional areas is flexible. Each functional area can include tasks, cases, and documents with core and custom attributes. The set of custom attributes is different for each type of task, case, or document.

A complete set of task attributes 12 comprises core task attributes 12a and custom task attributes 12b. FIG. 4 shows one implementation of core task attributes 12a including title, task description, instructions to appear to assignee, assigned to, compliance category, priority, effective date, due date, and duration. In some implementations, a newly created task 10 can include custom task attributes 12b related to a recurrence pattern, an email notification, an attached document that is associated with the task, and escalation processes. In some implementations, the task attributes 12 can be defined by a user, in some implementations some, or all of the attributes 12 can be preset depending on the type of task. Custom task attributes 12b can be changed or modified depending on the task types.

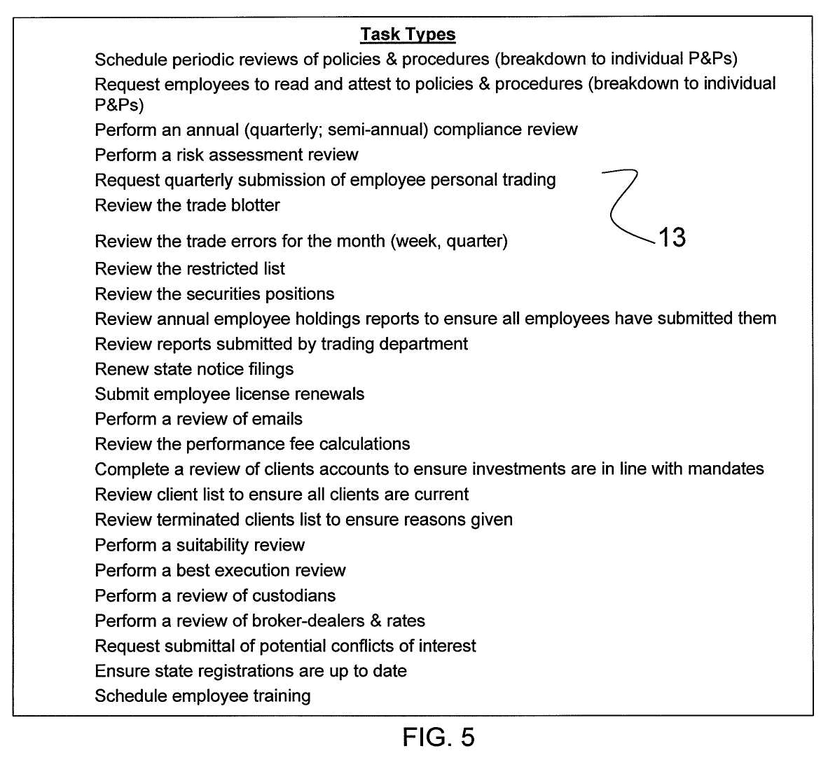

FIG. 5 shows a list of possible task types 13. These task types 13 can be associated with one or more functional areas depending on the task type. All tasks have a set of core attributes 12a that are common to all tasks 10 within a compliance system, regardless of functional area. The set of core attributes 12a can also be common across cases, assignments, and documents in some implementations. The core attributes can include priority, due date, category, and assignee. Task types 13 differ from each other because each task type has a set of custom attributes that are specific to that one task type. Some custom attributes 12b can be unique to a task type. In some implementations, the custom attributes 12b can be preset. In some implementations, the custom attributes 12b are determined by the organization depending on the tasks the organization includes in their compliance activities. The preset custom attributes 12b can be added or subtracted to tailor a task type to a particular industry, organization, or functional area. When a new task type is required or requested, the system administrator is able to quickly and easily create the new task type because system administrator simply adds the desired custom attributes 12b to the set of core task attributes 12a to create the new task type 13.

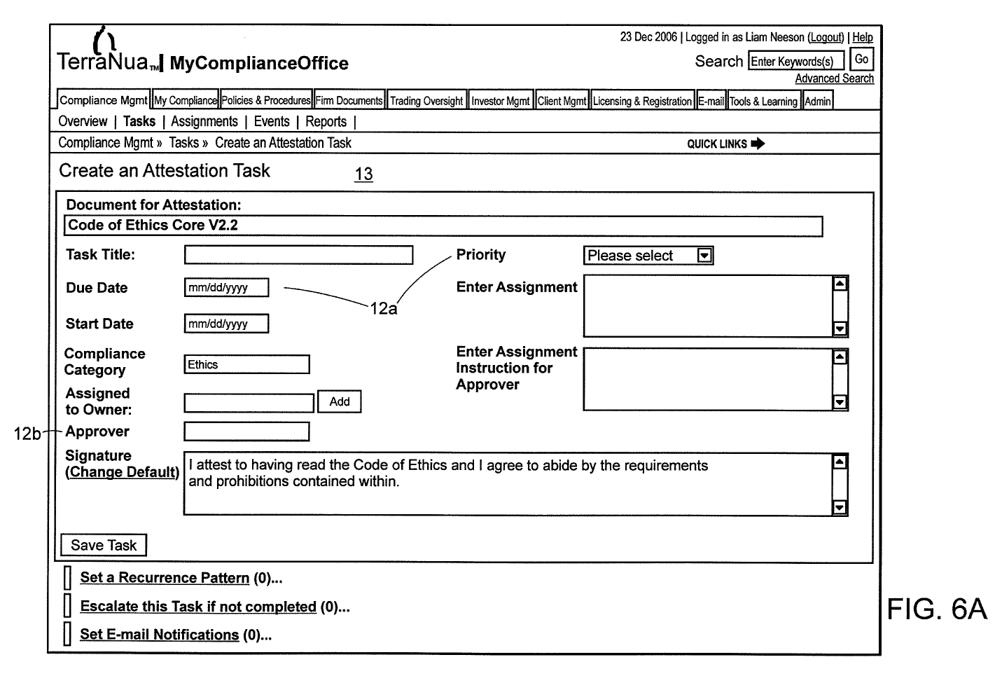

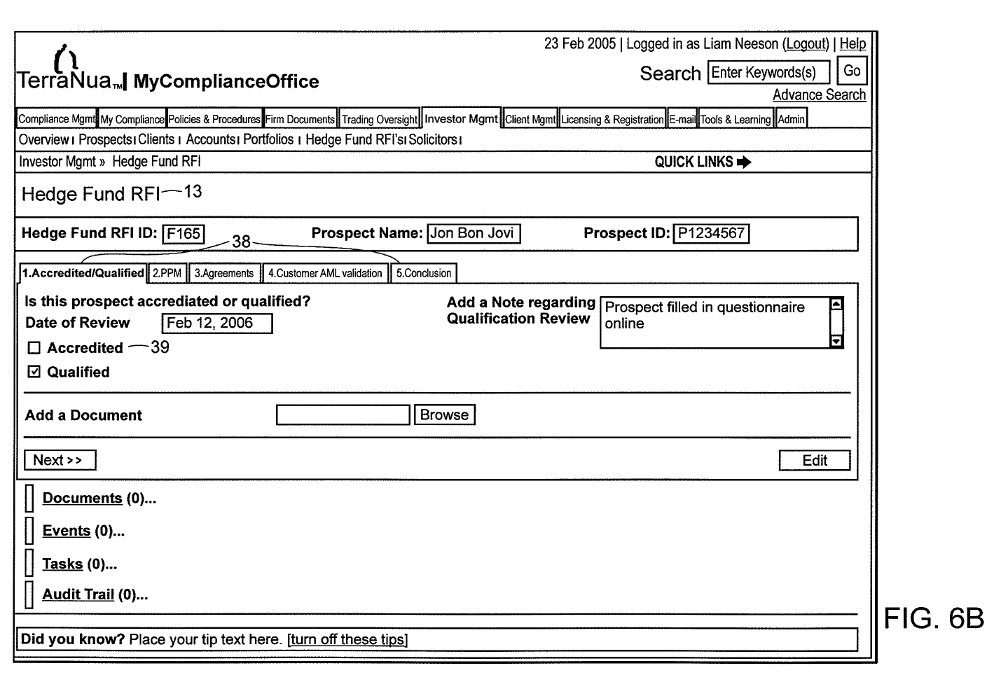

FIG. 6A shows an attestation task screen. An attestation task is a task type 13 related to reviewing a document and “attesting” that you have read the document. In this implementation, a user can define the core attributes 12a associated with this task, including due date, start date, category, and priority. The other attributes on this screen, including approver, signature, and assignment instruction for approver, are custom attributes specific to this attestation task type.

FIG. 6B shows an illustrative example of a workflow associated with an a specific task type (a hedge fund RFI 13). The five workflow steps 38 presented include 1. Accredited/Qualified, 2. PPM, 3. Agreements, 4. Customer AML validation, and 5. Conclusion. Each workflow steps has its own workflow attributes 39, and the combination of all workflow attributes combine into the one task type (the hedge fund RFI).

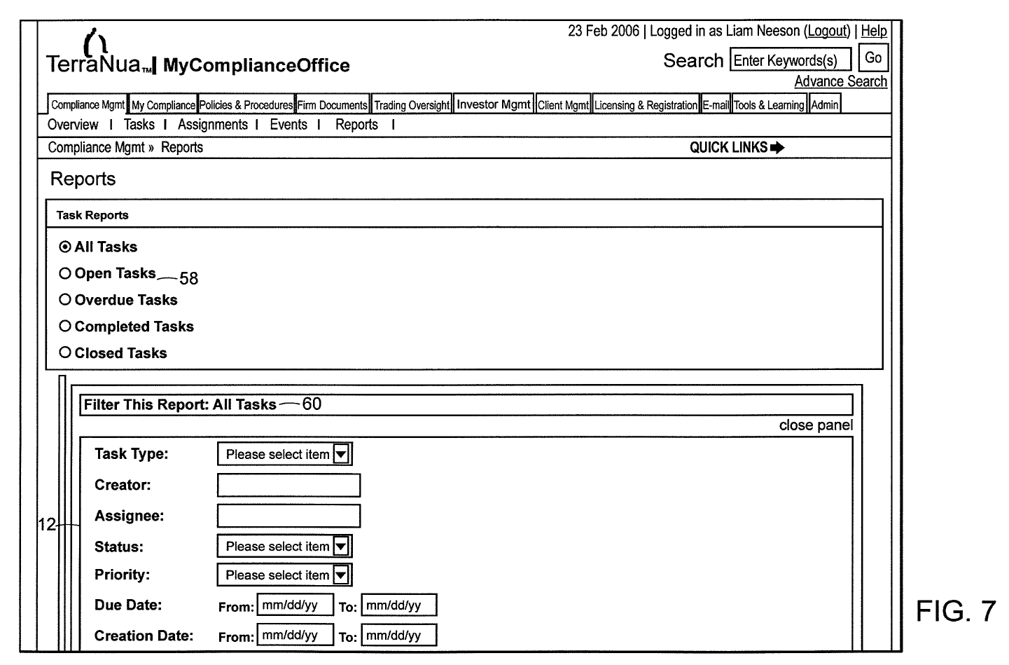

The compliance management system can generate a report related to any task, case or other information set in any functional area. FIG. 7 shows a screen used to determine the scope of a report. A report can be generated, in some implementations, to include the categories 58 of all task, open task, overdue tasks, completed task, or closed tasks. In some implementations, the report can include a filter 60 based on task type, creator, assignee, status, priority, due date, creation date, or any combination of these attributes. Other attributes (e.g. task attributes 12) can also be included in a filter 60 depending on the organization or the report needed. Based on the reports, a list can be created that displays the status of the selected attributes and the associated tasks, cases, or assignments.

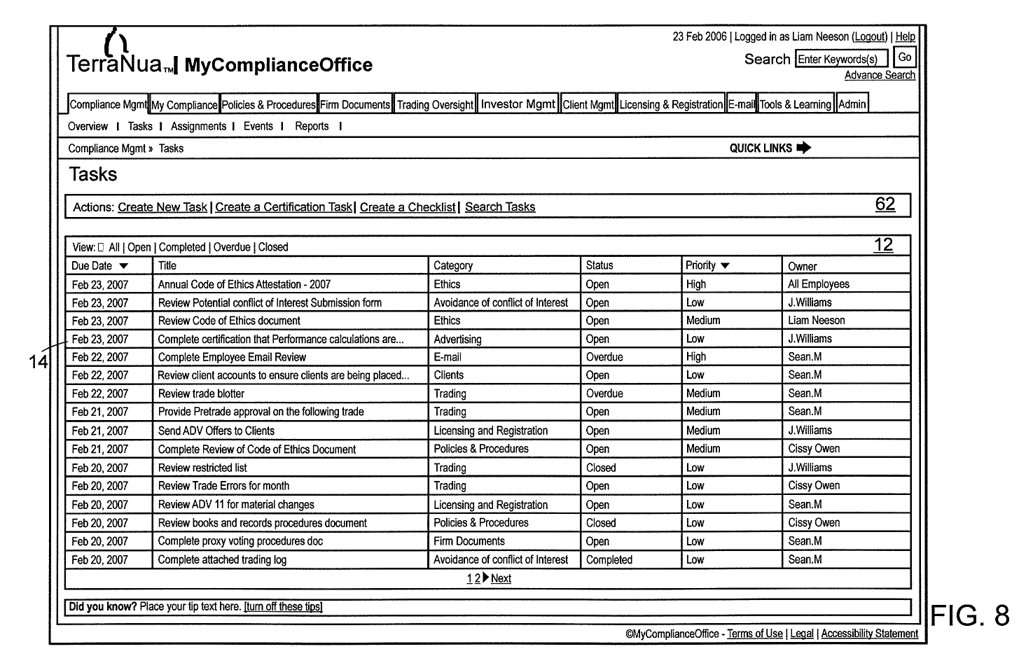

FIG. 8 shows a task list 14 collected under the Compliance Management functional area. Tasks can also be viewed as a complete list with specific or selected attributes displayed. The task list 14 can display attributes 12 that include the due date, title, category (i.e., compliance category), status, priority, and owner of the each task. This task list can be viewed in one implementation by a user who is a supervisor or compliance officer, or by a user who is responsible for overseeing the progress of a task. In one implementation, the viewer lists the task by due date, but the tasks can be arranged according to any of the set of core attributes (e.g., to review open tasks according to owner, priority, or status).

FIG. 8 shows that a user can perform certain actions associated with all of the tasks, a single task, or group of tasks. The actions 62 can include creating a new task, creating a certification task, creating a checklist, or searching the tasks. The ability to perform actions associated with the predefined tasks allows for a dynamic and real time management of existing and pending tasks.

An assignment, or individual instance of a task that is assigned to one or more people, is created after a task is processed through a workflow. If a task is created for three people and must be completed every quarter, then twelve assignments associated with the task are created over the course of a year. In some implementations, a task is associated with a single assignment. In other implementations, a task can be associated with a recurring or periodic assignments. In other implementations, a task can be associated with a workflow which has multiple steps each with their own group of one or more assignments.

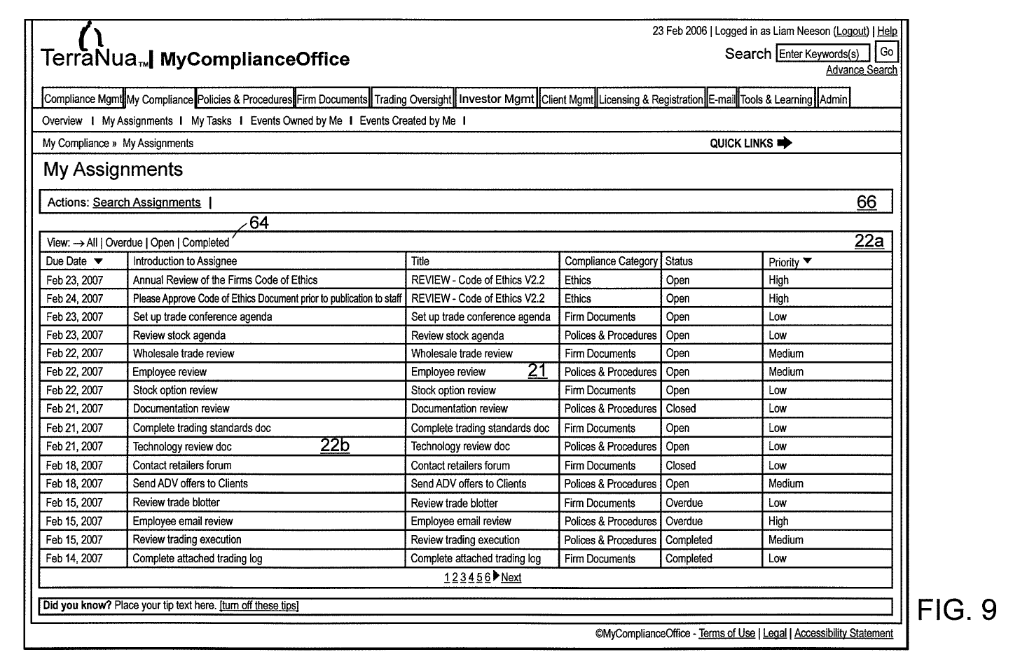

FIG. 9 shows an assignment list (“My Assignments”). In FIG. 9 all of the assignments 21 listed belong to a single person. Although a single task may be assigned to more than one person, a single assignment belongs to only one person. In some implementations, a user can view a list of assignments that belong to others who are supervised by the user. Each assignment is associated with a set of assignment attributes 22. All assignments share a set of core attributes 22a (e.g., priority, due date, compliance category, and assignee), and each assignment type is associated with a set of custom attributes 22b (e.g., introduction to assignee). Each combination of core attributes 22a and set of custom attributes 22b are unique to an assignment type. In some implementations, the assignment attributes 22 that are displayed reflect the associated task attributes 12. In FIG. 9 the core assignment attributes 22 displayed include due date, title, compliance category, status, and priority. In some implementations, the user can arrange or view his assignments based on the assignment attributes 22. In some implementations, the user may arrange or view his assignments (64) according to the status of the assignments, including overdue, open, and completed. In some implementations, the user can perform searches (66) for assignments based on search criteria including the core 22a and custom attributes 22b.

Cases are another feature of the compliance management system that allow an organization to ensure compliance with regulations and requirements. Cases, also referred to as issues or events, are unplanned or unexpected occurrences that an organization wishes to record and monitor through resolution. Cases can include client complaints, trade errors, licensing mistakes, or other irregularities. In some implementations, a case is created by a user who defines the case attributes. Case attributes can also be defined automatically when a certain task is not completed, or other monitor is triggered.

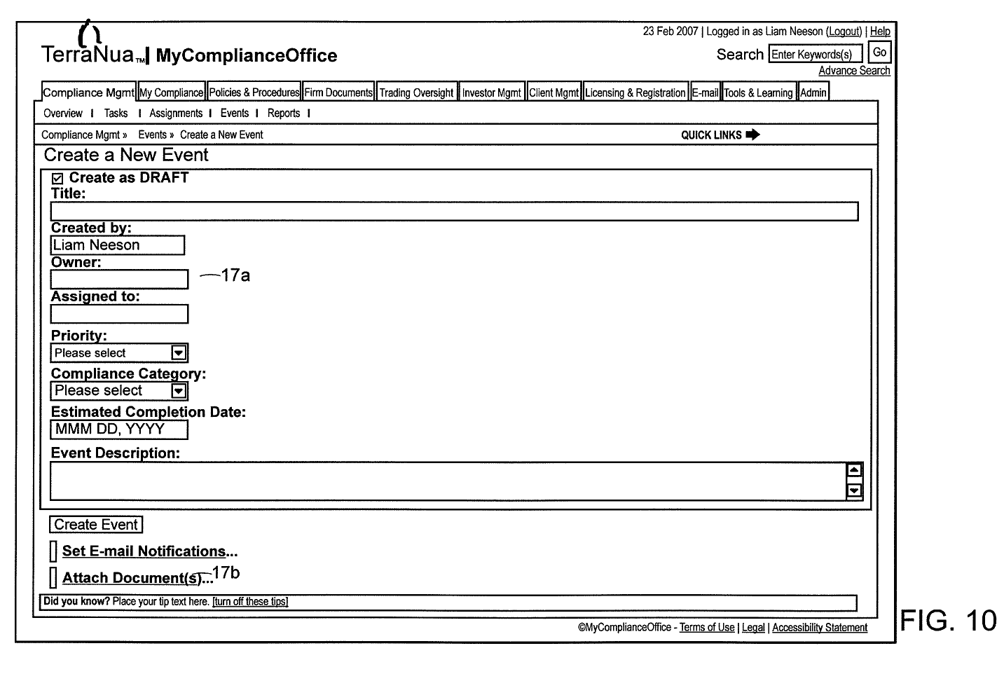

FIG. 10 shows a blank Create a New Case screen with case attributes 17 that have not been defined. A complete set of case attributes 17 for a case type is comprised of core case attributes 17a and custom case attributes 17b. Core case attributes can include an owner attribute that defines who is responsible for monitoring and ensuring that the case is resolved and an assigned to attribute that designates the individual or group of individuals who are responsible for resolving the case. Further attributes 17a can include a title attribute, a “created” by attribute, a priority attribute, a compliance category, an estimated completion date, and a case description. In some implementations, the user can also define custom attributes 17b including email notifications and attaching one or more documents to the case. Similar to tasks, different case attributes 17b can be chosen for different case types.

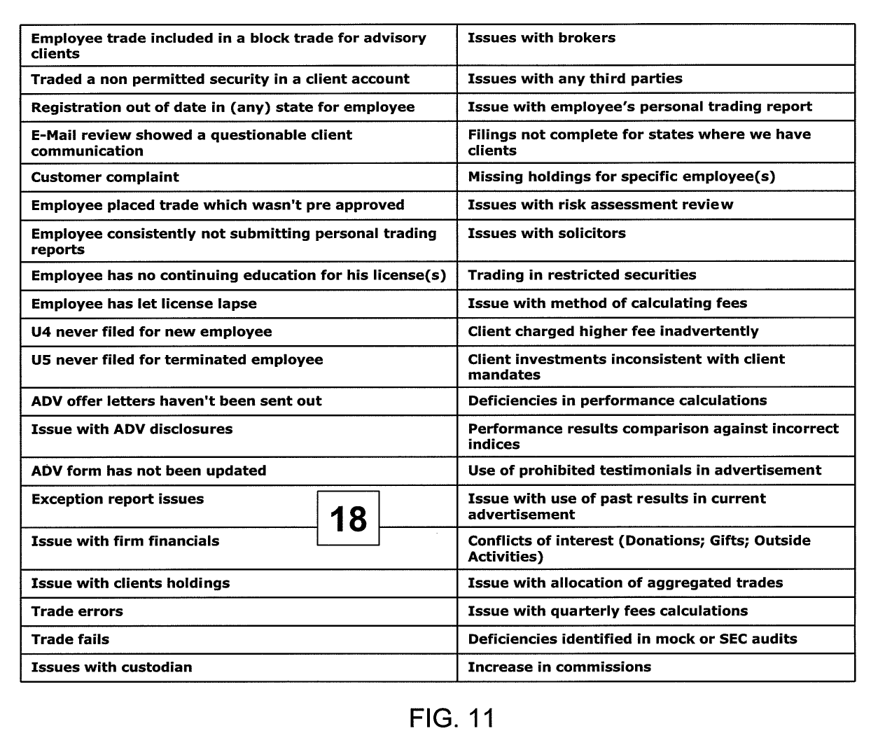

FIG. 11 shows an illustrative list of possible case types 18. The list shown is not an exhaustive list of all types, but shows that case types may be specific to one functional area; other case types may be associated with more than one functional area. All case types have a set of core attributes that are common across cases, regardless of functional area. The core attributes can include priority, due date, compliance category, assignee, and owner. The core set of attributes can be preset or tailored to the industry and/or organization. Case types differ from each other because each case type has a set of custom attributes that are specific to it. In some implementations, the custom attributes are preset for all case types. In some implementations, the custom attributes are determined by the organization depending on the cases the organization monitors as part of their compliance activities. The preset custom attributes can be added or subtracted to tailor a case type to a particular industry, organization, or functional area.

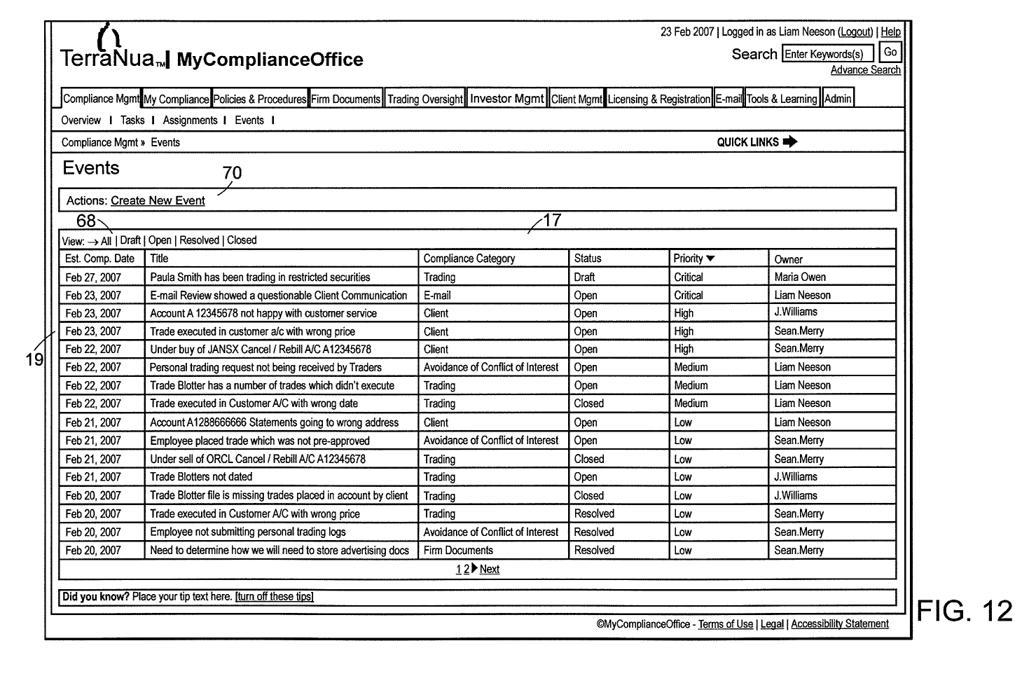

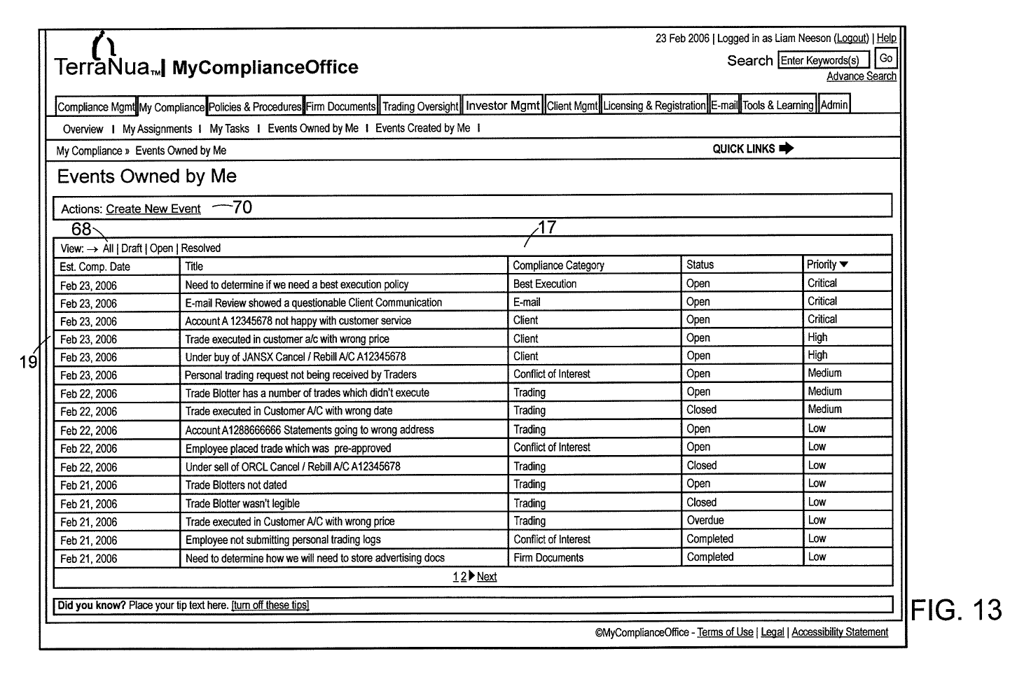

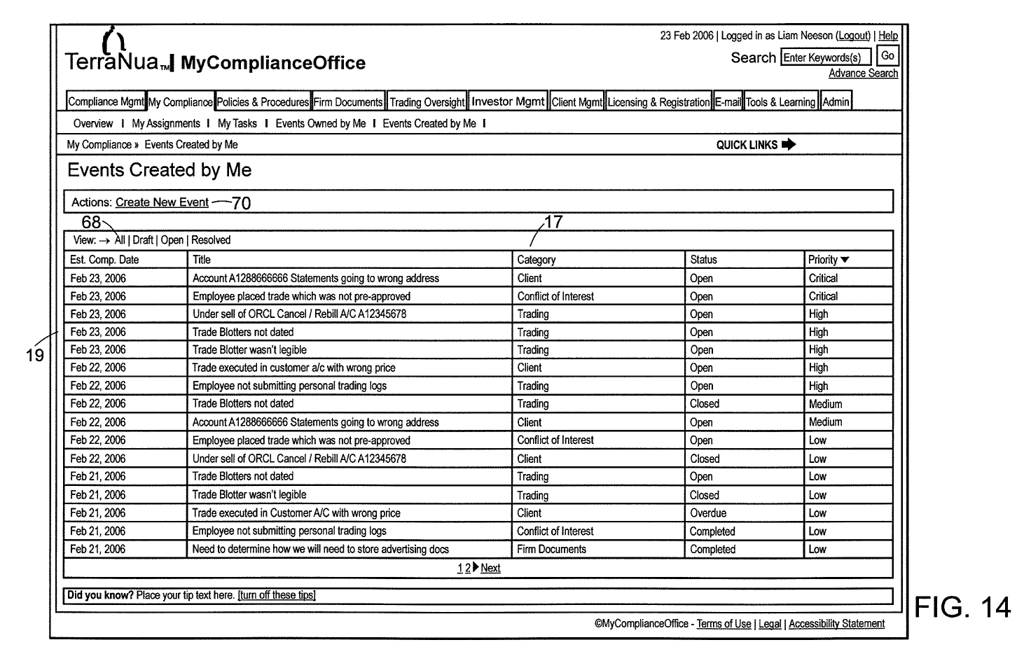

A case list, also referred to as an event list, can also be created that reflects all cases, all cases associated with a specific functional area (FIG. 12), all cases that are owned by a user (FIG. 13), or all cases that were created by a user (FIG. 14). Case lists that are associated with a specific functional area, as illustrated in FIG. 12, enables a user to review the status or list of all cases 19 associated with that functional area in a single place. A case list can also be modified to view (68) drafts of cases, all open cases, resolved cases, or closed cases. In some implementations, the case list displays can include case attributes 17, for example, an estimated completion date attribute, a title attribute, compliance category, status, priority, and owner attribute. In some implementations, the cases list can be arranged or viewed based on any of the attributes. A user can also create (70) a new case, or event, from a case list page.

A user can also limit the displayed cases based on other criteria including all the cases that are owned by the user (e.g., FIG. 13) or cases that were created by the user (e.g., FIG. 14). FIG. 13 shows the user the list of cases that the user is responsible for monitoring and recording the resolution and method of resolution of the cases. FIG. 14 shows the user the of cases that the user originally recorded. The case lists shown in FIGS. 13 and 14 are valuable because a case owner or case creator may not receive any assignments or follow-up notification regarding a particular case. In some implementations, a user can view (68) drafts of cases, all open cases, resolved cases, or closed cases. In some implementations, a case list 19 display includes case attributes 17, for example, the estimated completions date attribute, the title attribute, compliance category, status, priority, and owner. In some implementations, the cases list can be arranged or viewed based on any of the attributes 17.

Another feature of the compliance management system is document management that allows documents to be stored and associated with the tasks and cases. The documents can include any document that can be opened and/or managed on a computer. Examples of documents includes WORD™ documents, EXCEL™, POWER-POINT™, and PDFs. A single document library can be maintained for the entire compliance management system. In some implementations, an organization may elect to maintain document libraries for each functional area, or allow users to view document sub-libraries, also referred to as folders, that are formed from a larger general document library.

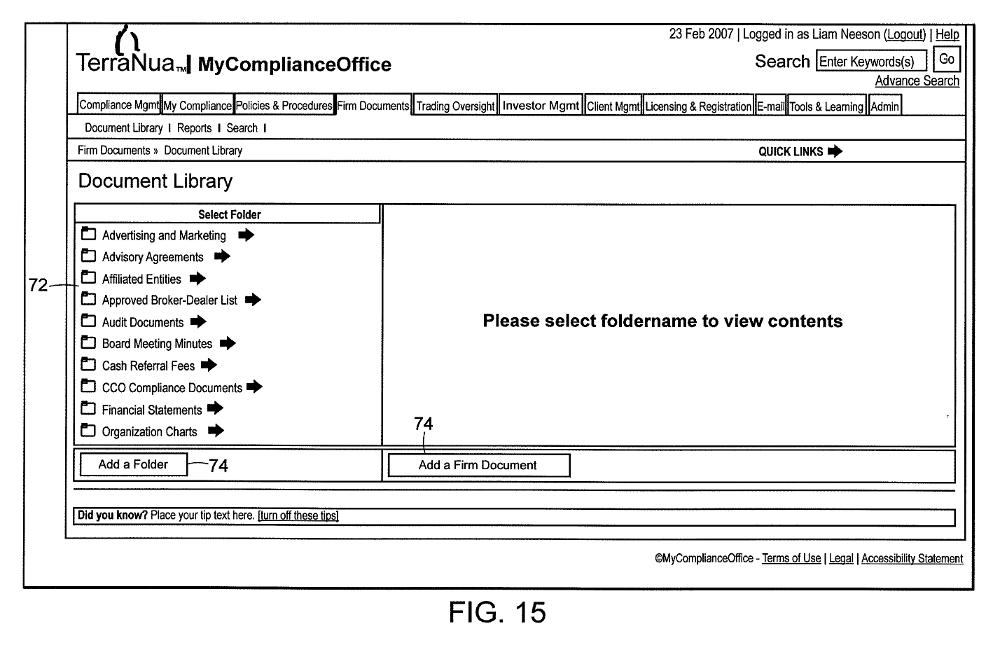

FIG. 15 shows a document library in the firm documents functional area 42. The document library can also be viewed according to folders 72, also referred to as sub-libraries. Within the document libraries, folders and documents can be added (74) to a document library by moving or copying within the compliance management system (for example, from one functional area to another, or from one folder to another). In some implementations, documents can be retrieved from external sources, for example hard drives, emails, or other document sources.

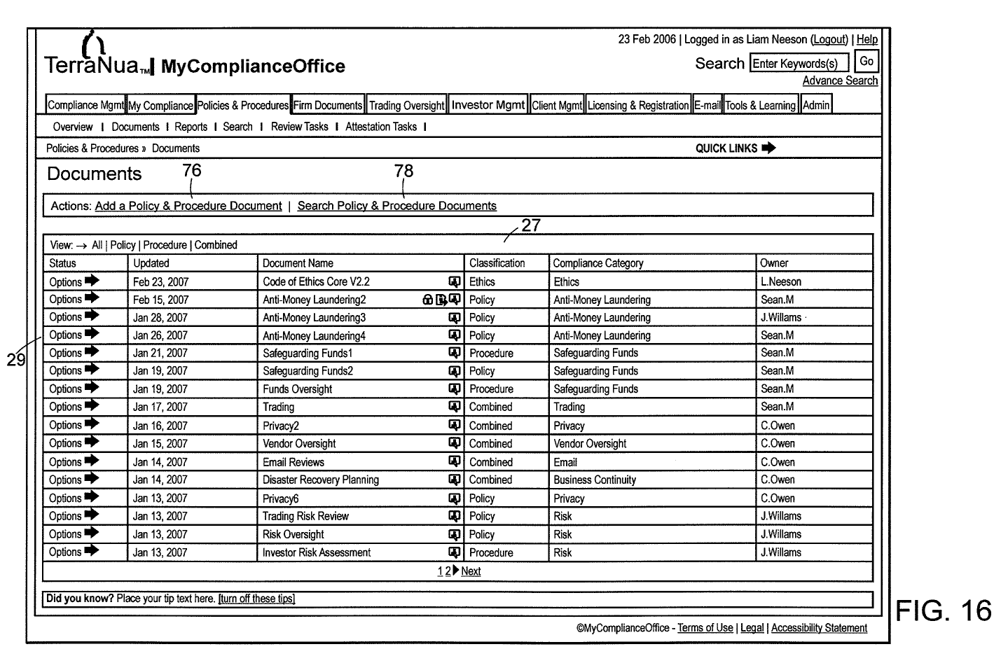

FIG. 16 shows a document list 29 associated with the policies and procedures functional area. When documents are viewed in a list format, the documents are displayed based on the document attributes 27. Document attributes include both core attributes and custom attributes. Document attributes 27 can include status attributes, an updated attribute that shows when the document was last updated or modified, a document name attribute, a classification attribute, a compliance category attribute, and an owner category. Other attributes can include the name of the tasks or cases that the document is associated with. A user can add (76) a document to a document library, or search (78) the document library.

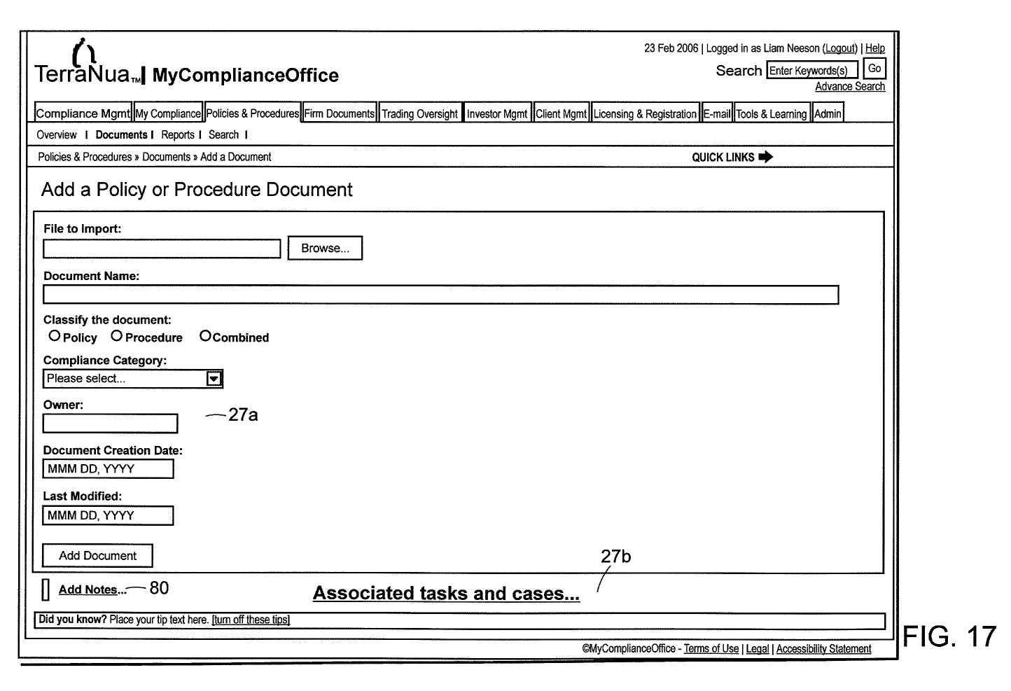

FIG. 17 shows a screen used to add a policy or procedure document. A policy and procedure document is one example of a document type 28. To add a document to a document library, the document attributes 27 must be defined. In some implementations the set of core document attributes 27a include retrieving the file to be imported, the document(s) name, the document classification which can include the functional area or document type, the compliance category, the document owner, the document creation date, and the last modified date. In some implementations, the user adding the document can also attach notes (80) to the imported document attributes reflecting the reason for adding the document or other important information related to the document. The custom document attributes 27b can also include document creator, or the cases or tasks associated with the document.

In other implementations, an organization can collect additional information relevant to the core and/or custom attributes of the tasks, cases and documents. The additional attribute information is often particularly useful to the organization and/or industry of the user. The additional attribute information becomes available to a user who drills down into the task, case, or document and retrieves information related to one of the defined attributes. In some implementations, the additional attribute information can allow a user to view all tasks, events, and/or documents associated with the one defined attribute. The additional attribute information can also be viewed in relation to the functional areas that have tasks, cases, and documents. In some implementations, the additional attribute information can be added through additional attribute information pages and displayed in a list format arranged or viewed according to selected filters. The additional attribute information can also be further defined based on sub-attributes. Sub-attributes can include core attributes and/or custom attributes. The additional attribute information can include client information, account information, prospect details, and restricted stock information.

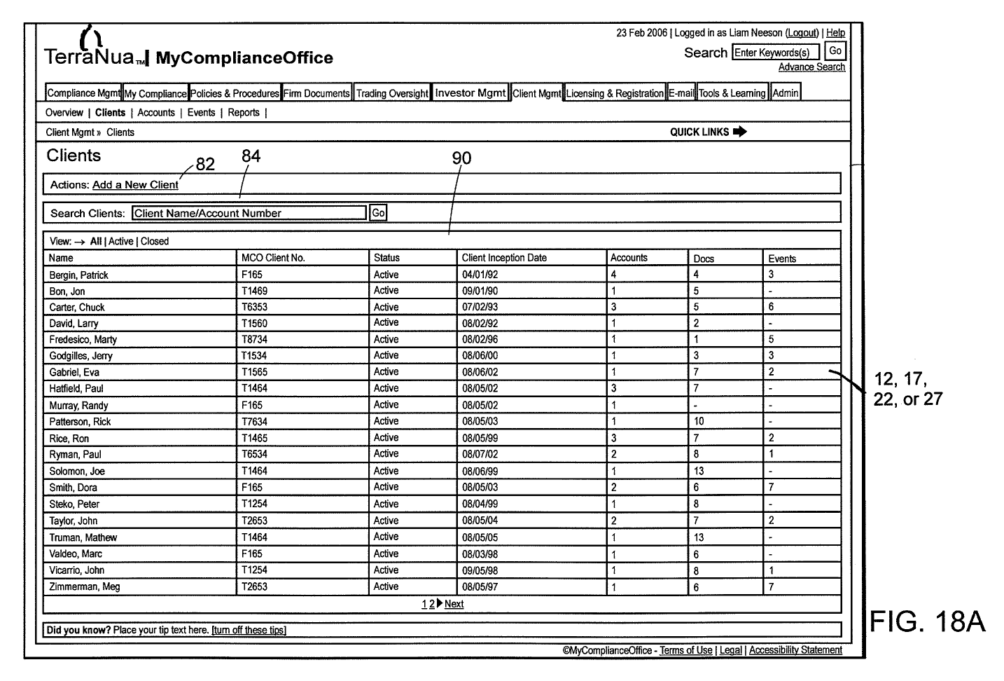

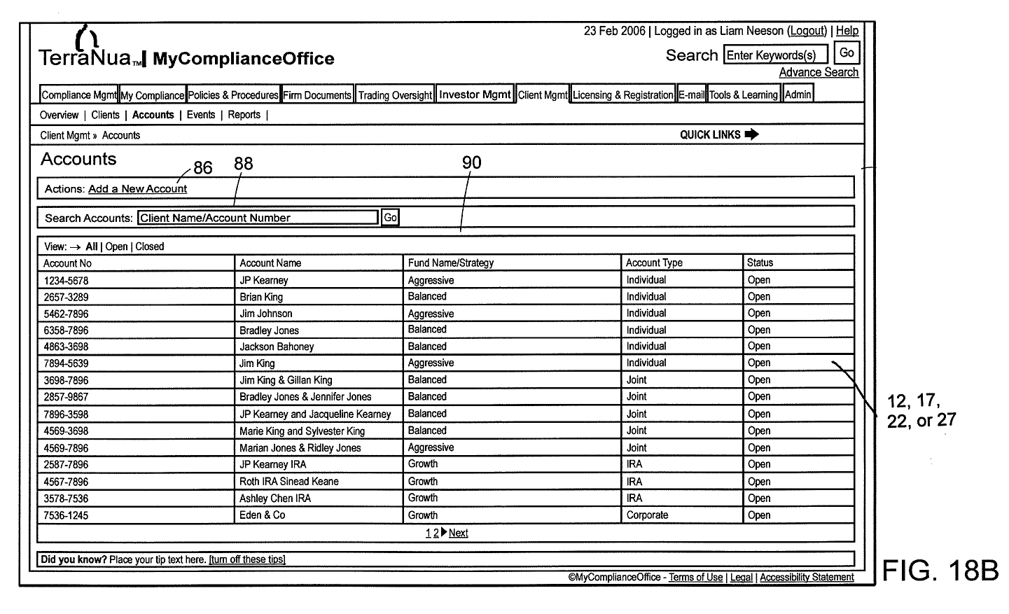

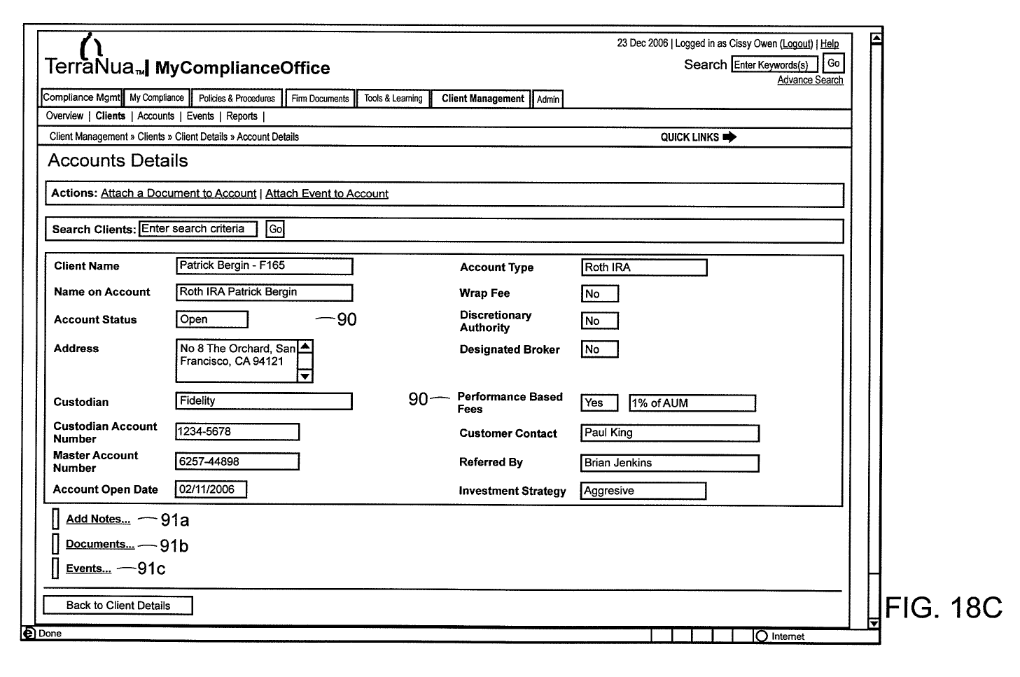

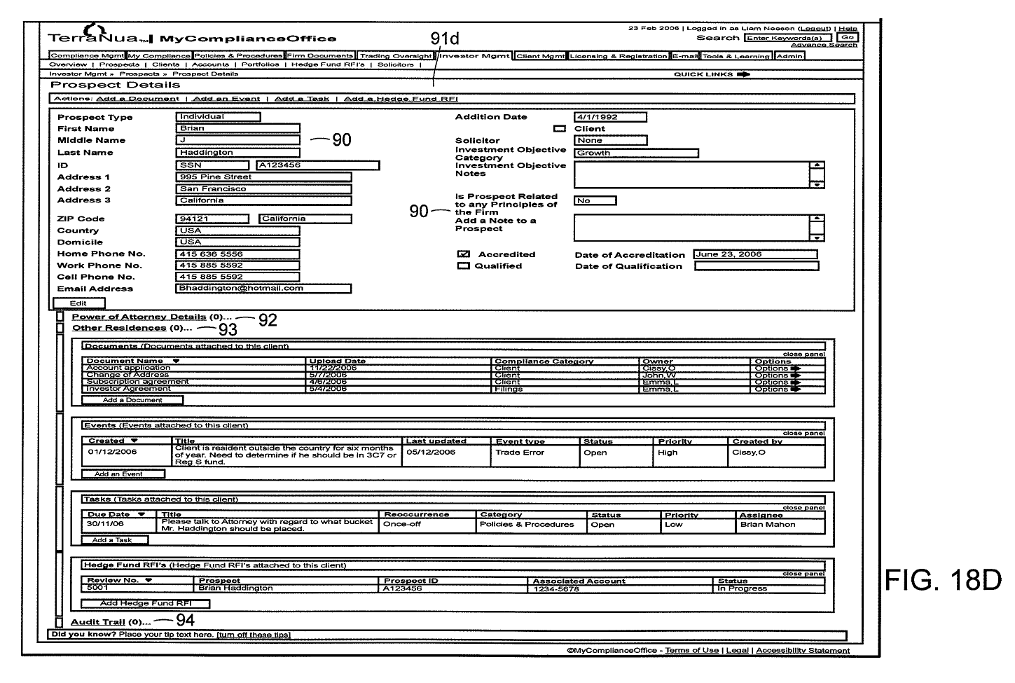

FIGS. 18A-18D show illustrative examples of additional industry specific data. Industry specific data can include in some implementations, lists of clients, accounts, prospects, portfolios, hedge fund RFI's. The information in these lists can also be defined by sub-attributes and can be viewed or arranged based on any sub-attributes similar to the task, cases, and documents. The displayed sub-attributes can be pre-selected. In some implementations, the user can select the sub-attributes that they wish to have displayed.

FIG. 18A and FIG. 18B show illustrative examples of client and account lists. Client names and account numbers would be considered attributes of a task, case or assignment. However, list of attributes can also be viewed independently of the parent task, case or document, and the additional attribute information can be presented based on the sub-attributes. The information in these lists can be viewed or arranged based on any sub-attributes similar to tasks, cases, and documents. The displayed sub-attributes can be pre-selected. In some implementations, the user can select the sub-attributes that they wish to have displayed.

FIG. 18A shows a list of client attributes 12, 17, 22, or 27 that may be associated with a task, case, assignment, or document. In one implementation, the sub-attributes 90 include MCO client number, status, client inception date, number of accounts, number of associated documents, and number of associated cases. These sub-attributes can also be drilled down into to display the information related to the cases associated with a specific client. Client information may also be searched (82) according to client name or account number, and new clients may be added (84) as an associated action.

FIG. 18B shows the sub-attributes 90 used in some implementations of an account list, including the account number, the account name, the fund name or strategy, the account type, and the status of the account. The actions that are associated with this information type include adding (86) a new account and/or searching (88) the accounts by client name or account number. The account list could also be searched based on any of the associated sub-attributes.

When a user is interested in the information related to one or more entries in the additional attribute information lists (e.g., FIG. 18A and FIG. 18B), he/she can drill down into the list to view the all of the defined sub-attributes 90 associated with the additional attribute information.

FIG. 18C and FIG. 18D shows screens that display the sub-attributes associated with an additional attribute information entry. FIG. 18C shows account detail sub-attributes 90. FIG. 18D shows prospect details and the associated sub-attributes 90. In some implementations, a user can add notes 91a, view, retrieve, or associate new documents 91b, view or link tasks and/or cases 91c, or associate a hedge fund RFI 91d to the additional attribute information page. Additional attribute information detailed pages can also be linked to other additional attribute information pages. In some implementations, an account details page can be linked to the client details page of the account owner. A user can view associated information including power of attorney documentation 92, other residences of the prospect 93, documents associated with the prospect 91b, associated tasks, associated cases 91c, and hedge fund RFI's 91d. In some implementations, the user can reference an audit trail associated with the prospect 94.

The identifiers for the industry-specific data elements, also referred to as additional attribute information, such as client, prospects, and portfolios can be used as attributes in a task type or a case type. This allows reporting of all cases or tasks by industry specific data element.

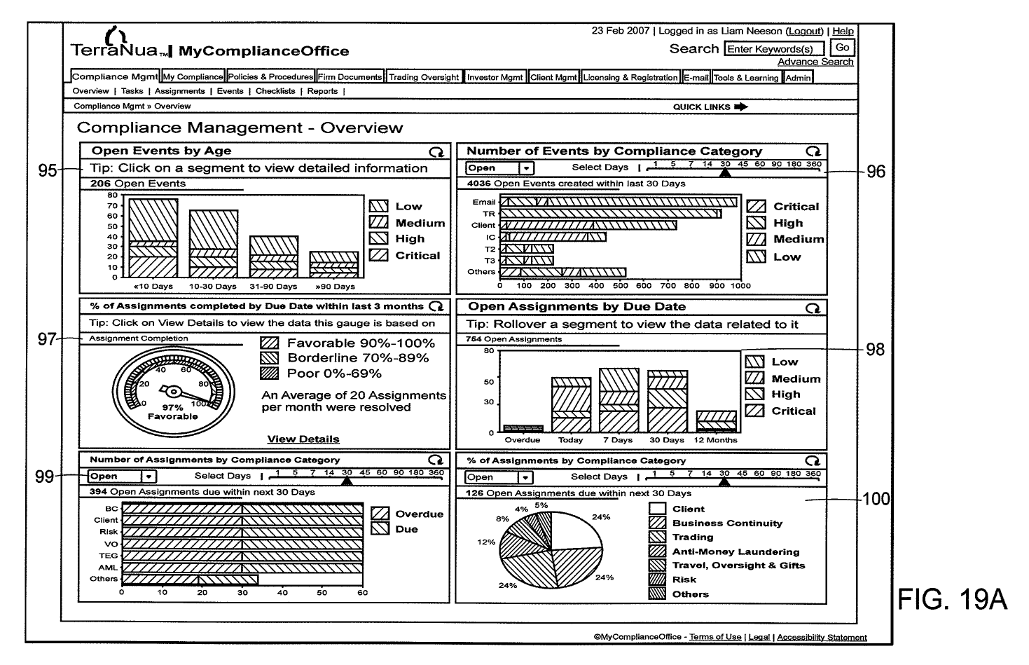

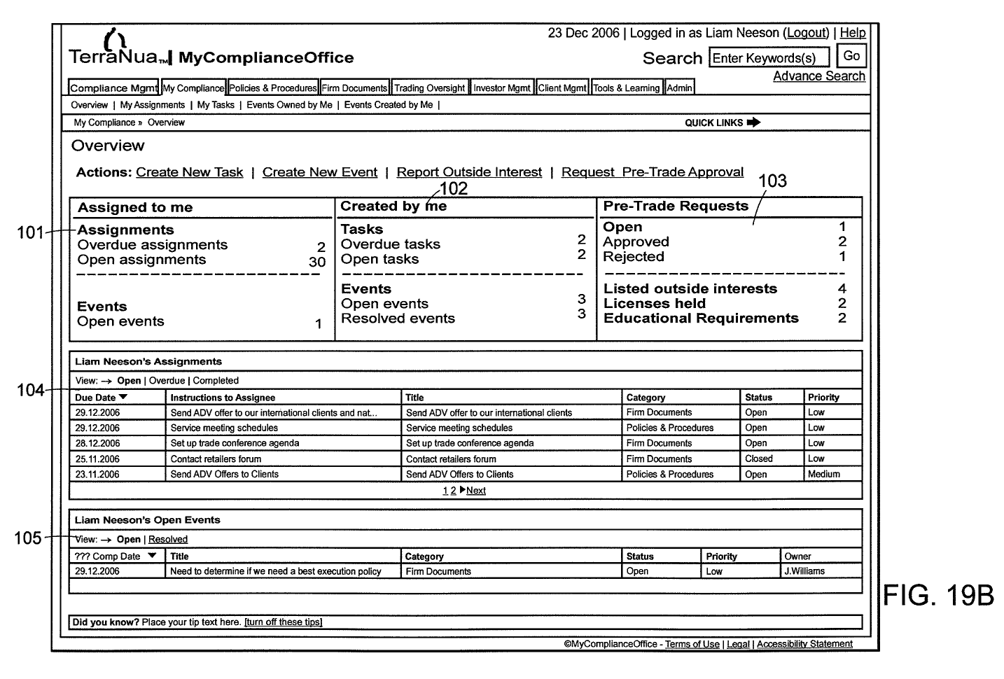

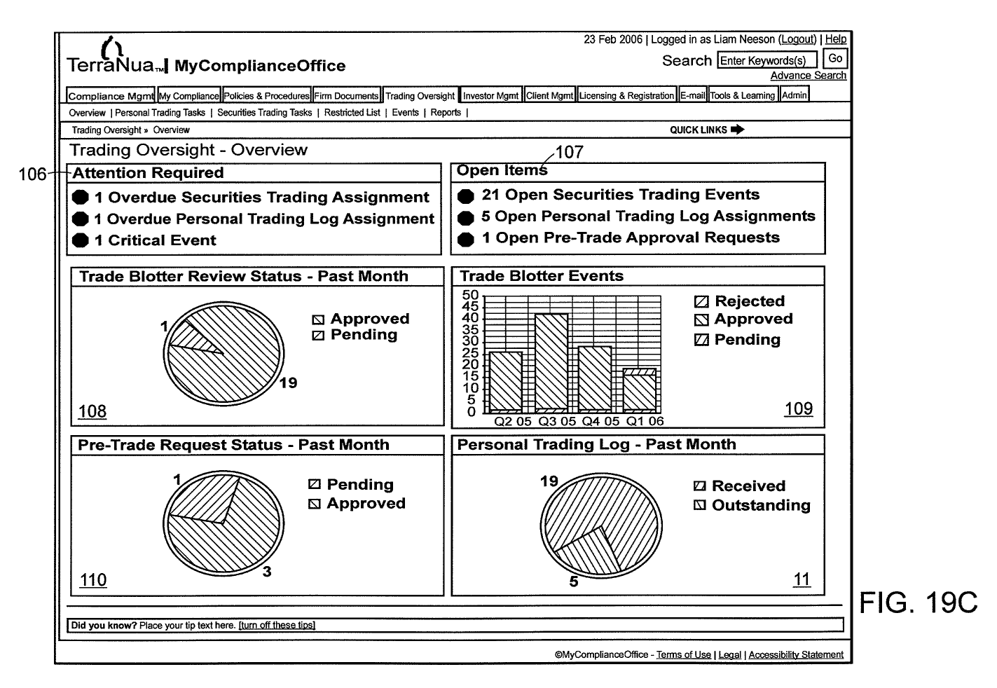

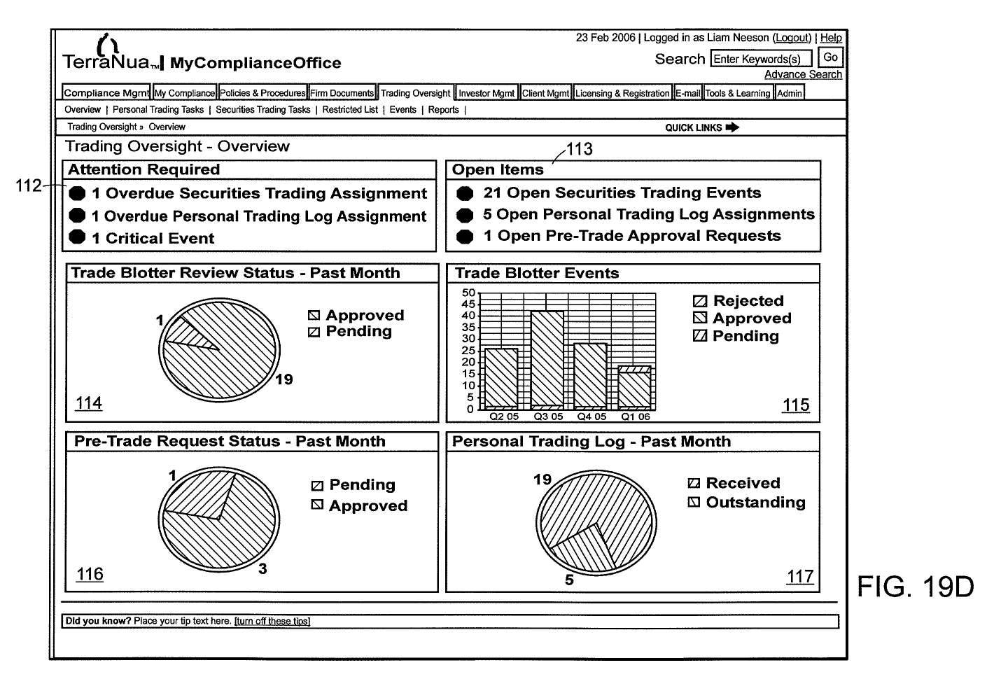

FIG. 19A-19D shows some implementations of an overview page. In FIG. 19A the overview of multiple cases and assignments is displayed through the use of graphs and pie charts. As these overview diagrams are for all cases or assignments, they can display or filter data based on the core attributes. The displays can depend on filters that include age of cases 95, number of cases by compliance category 96, completion of assignments 97, open assignments by due date 98, assignments by compliance category 99, and percentage of assignments by compliance category 100. Different reports that filter based on custom attributes generate reports that only include specific task or case type that include the custom attribute. In FIG. 19B text and lists are used to show the status of the assignments and cases for a single user. The user can view assignments and events that were assigned to the user 101, created by the user 102, and also information related to a specific task type 103 (e.g., pre-trade requests). The user's overview can also list all assignments 104, and open events 105. In FIG. 19C a combination of pictorial and textual methods is used to display the status of tasks and cases for a specific functional area (trading). Functional specific overviews can display attention required categories 106 and open item categories 107. Overviews for a specific functional area can be generate based on custom-attribute filters including trade blotter review status 108, trade blotter events 109, pre-trade request status 110, and personal trading log results 111. In FIG. 19D, a combination of pictorial and textual methods is used to display the status of tasks and cases for a specific functional area (investor management). This includes the use of custom attributes specific to a task or event type designed for that functional area. The functional area specific categories that can be displayed include items where attention is required 112, a conversion overview 113, a fund solicitation overview 114, qualified purchasers 115, AML validations completed in the past month 116, and investor related cases 117.

The above-described techniques can be implemented in digital electronic circuitry, or in computer hardware, firmware, software, or in combinations of them. The implementation can be as a computer program product, e.g., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the invention by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (“IC”), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (“PBX”). In any of these cases, implementation may be achieved either by writing applications that are native to the chosen platform, or by interfacing the platform to one or more external application engines.

To provide for interaction with a user, the above described techniques can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communications, e.g., a communications network. Examples of communications networks, also referred to as communications channels include a local area network (“LAN”) and a wide area network (“WAN”), e.g., the Internet, and include both wired and wireless networks. Unless clearly indicated otherwise, communications networks can also include all or a portion of the PSTN, for example, a portion owned by a specific carrier.

The computing system can include clients and servers. A client and server are generally remote from each other and typically interact through a communications network. The relationship of client and server arises by virtue of computer programs running on the respective computers and having a client-server relationship to each other.

The invention has been described in terms of particular embodiments. The alternatives described herein are examples for illustration only and not to limit the alternatives in any way. The steps of the invention can be performed in a different order and still achieve desirable results. Other embodiments are within the scope of the following claims.

What is claimed is:

1. A computer system for managing compliance, the system comprising:
a task module configured to:
process a task comprising task attributes,
to associate the tasks with a workflow, and
to assign the task to one or more individuals based on a task assignment attribute, the task assignment attribute representing one or more individuals responsible for the task;
a case module configured to:
process a case comprising case attributes, the case attributes comprising an owner attribute representing one or more individuals responsible for monitoring the case, and a case assignment attribute representing one or more individuals responsible for resolving the case,
track the resolution and method of resolution of the case; and
a document module configured to:
store or retrieve one or more documents, and
associate the one or more documents with one or more tasks or cases.

2. The computer system of claim 1 further comprising an application server configured to generate a report based on a filter that includes task attributes, case attributes, or any combination thereof.

3. The computer system of claim 1 further comprising a storage module configured to maintain data related to documents, task and case data, workflow data, user and customer data, and data for specific industry needs.

4. The storage module of claim 1 further configured to maintain data related to emails, instant messages, and voicemail.

5. The computer system of claim 1 further comprising a notification module wherein the notification module is configured to send emails or updates to the one or more individuals identified by the task assignment attribute, the cases assignment attribute, the cases owner attribute, or any combination thereof.

6. The computer system of claim 1 further comprising an application specific module, wherein the application specific module maintains data specialized to an industry or user group.

7. The computer system of claim 1 further comprising one or more servers wherein the task module, the case module, the document module, the storage module, the application specific module, or any combination thereof reside on the one or more servers.

8. A computerized method for managing compliance, the method comprising:
defining a set of core task attributes associated with a task, the task attributes include an assignment attribute that identifies one or more individuals who are responsible for the task, a compliance category attribute, a recurrence pattern attribute, an email notification attribute, at least one escalation attribute, and at least one associated document attribute;
associating the task with a workflow;
assigning the task to one or more individuals based on the assignment attribute, and notifying the one or more individuals identified by the assignment attribute;
recording a case by defining a set of core case attributes, the set of core case attributes comprising a compliance category attribute, an owner attribute representing one or more individuals responsible for monitoring the case, an assignment attribute representing one or more individuals responsible for resolving the case, or any combination thereof, and
notifying the one or more individuals identified by the assignment or owner attributes of the case; and
storing documents in a central document database.

9. The method of claim 8 further comprising associating one or more of the documents with the task or case.

10. The method of claim 8 further comprising generating a report page, based on a filter that includes at least the task or case attributes.

11. The method of claim 8 further comprising generating an overview page wherein the overview page reflects a status of the tasks and cases.

12. The method of claim 8 further comprising executing a reminder or notification process before an assignment is due.

13. The method of claim 8 further comprising executing an escalation process if an assignment is not completed before a due date.

14. The method of claim 8 further comprising associating the task with a task type, the task type comprising the set of core task attributes.

15. The method of claim 14 wherein the task types further comprise a set of custom attributes.

16. The method of claim 14 further comprising mapping planned compliance activities to a plurality of task types.

17. The method of claim 16 wherein a plurality of compliance activities comprises all compliance activities of an organization, group, or industry.

18. The method of claim 15 further comprising defining a plurality of predefined task types that are associated with a functional area.

19. The method of claim 18 wherein one or more of a plurality of functional areas are associated with an organization, group, or industry.

20. The method of claim 8 further comprising associating the case with a case type, the case type comprising the set of core case attributes.

21. The method of claim 20 wherein the case types further comprise a set of custom case attributes.

22. The method of claim 21 further comprising mapping unplanned compliance activities to a plurality of case types.

23. The method of claim 22 wherein a plurality of compliance activities comprises all compliance activities of an organization, group, or industry.

24. The method of claim 21 further comprising defining a plurality of predefined case types that are associated with a functional area.

25. The method of claim 24 wherein one or more of a plurality of functional areas are associated with an organization, group, or industry.
